(19) United States
(12) Patent Application Publication
(10) Pub. No.: US 2026/0169655 A1
(43) Pub. Date: Jun. 18, 2026

(54) STORAGE DEVICE, STORAGE CONTROLLER, AND OPERATING METHOD OF STORAGE CONTROLLER

(71) Applicant: SAMSUNG ELECTRONICS CO., LTD., Suwon-si (KR)

(72) Inventors: Sungup Moon, Suwon-si (KR); Byungyo Lee, Suwon-si (KR)

(73) Assignee: SAMSUNG ELECTRONICS CO., LTD., Suwon-si (KR)

(21) Appl. No.: 19/262,757

(22) Filed: Jul. 8, 2025

(30) Foreign Application Priority Data
Dec. 16, 2024 (KR) 10-2024-0187474

(51) Int. Cl. G06F 3/06; G06F 40/279

(52) U.S. Cl. CPC G06F 3/0659; G06F 3/0613; G06F 3/0656; G06F 3/0679; G06F 40/279

(57) ABSTRACT

A storage device includes: a storage controller including an embedding model buffer and an accelerator; and a nonvolatile memory operatively connected to the storage controller, wherein the nonvolatile memory is configured to store target data and model data of an embedding model, and, wherein the storage controller is configured to: based on a first request from a host, transmit a read command for the target data to the nonvolatile memory, receive the target data from the nonvolatile memory, and generate an embedding vector using the accelerator based on the received target data and the model data loaded into the embedding model buffer; and based on a second request from the host, transmit, to the host, the target data and the generated embedding vector.

### CROSS-REFERENCE TO RELATED APPLICATION

This application is based on and claims priority under 35 U.S.C. § 119 to Korean Patent Application No. 10-2024-0187474, filed on Dec. 16, 2024, in the Korean Intellectual Property Office, the disclosure of which is incorporated by reference herein in its entirety.

### BACKGROUND

The present disclosure relates to a memory device, and more particularly, to a storage device, a storage controller, and an operating method of the storage controller.

With recent advances in artificial intelligence (AI) technologies, demands for systems equipped with AI capabilities are growing exponentially. The basis of this growth lies in various large models, including Large Language Models (LLMs), and technologies such as vector databases (Vector DBs) are gaining attention.

In AI training and/or inference tasks, generating embedding vectors for input data is essential. Typically, the generation of these embedding vectors is performed by reading embedding model data, which may reach tens of megabytes (MB), and transferring the same to a high-speed computing device, such as a Graphics Processing Unit (GPU) or a Neural Processing Unit (NPU), while an input data file is separately transferred from a storage device through the host's memory to the GPU or NPU outside the storage device. However, such a data transfer process incurs significant communication overhead and is a major factor in degrading system performance.

Additionally, in AI training and/or inference systems, since the GPU or the NPU (outside the storage device) is used to process large-scale AI models, performing additional computations for generating embedding vectors may lead to excessive consumption of the resources of the GPU or the NPU outside the storage device.

### SUMMARY

The present disclosure provides a storage device, a storage controller, and an operating method of the storage controller, which greatly improve performance of an artificial intelligence (AI) system through optimization of data processing and resource utilization by supporting offloading in a manner of performing an embedding vector generation operation on-device in the storage device and transmitting generated embedding vectors to an application.

According to an aspect of the disclosure, a storage device includes: a storage controller including an embedding model buffer and an accelerator; and a nonvolatile memory operatively connected to the storage controller, wherein the nonvolatile memory is configured to store target data and model data of an embedding model, and, wherein the storage controller is configured to: based on a first request from a host, transmit a read command for the target data to the nonvolatile memory, receive the target data from the nonvolatile memory, and generate an embedding vector using the accelerator based on the received target data and the model data loaded into the embedding model buffer; and based on a second request from the host, transmit, to the host, the target data and the generated embedding vector.

According to an aspect of the disclosure, a storage controller configured to control a nonvolatile memory where target data and model data of an embedding model are stored, includes: an embedding model buffer; and an accelerator, wherein the storage controller is configured to: based on a first request from a host, transmit a read command for the target data to the nonvolatile memory, receive the target data from the nonvolatile memory, and generate an embedding vector using the accelerator based on the received target data and the model data loaded into the embedding model buffer; and based on a second request of the host, transmit the target data and the generated embedding vector to the host.

According to an aspect of the disclosure, an operating method of a storage controller including an embedding model buffer and an accelerator, and controlling a nonvolatile memory, includes: transmitting a read command for target data to the nonvolatile memory based on a first request from a host; receiving the target data from the nonvolatile memory, and generating an embedding vector using the accelerator based on the received target data and model data loaded into the embedding model buffer; and based on a second request from the host, transmitting the target data and the generated embedding vector to the host.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a storage system according to an embodiment;

FIG. 2 illustrates a storage device according to an embodiment;

FIG. 3 illustrates a nonvolatile memory (NVM) according to an embodiment;

FIG. 4 illustrates a storage controller according to an embodiment;

FIG. 5 illustrates an operating method of a storage device according to an embodiment;

FIG. 6 illustrates an operating method of a host, a storage controller, and a nonvolatile memory device according to an embodiment;

FIG. 7 illustrates an operation method of a host, a storage controller, and a nonvolatile memory device according to an embodiment;

FIG. 8 illustrates an operating method of a host, a storage controller, and a nonvolatile memory device according to an embodiment;

FIG. 9 illustrates an operating method of a host, a storage controller, and a nonvolatile memory device according to an embodiment; and

FIG. 10 illustrates a system with a storage device according to an embodiment.

### DETAILED DESCRIPTION

Hereinafter, one or more embodiments are described with reference to the attached drawings. The same reference numerals are used for same components in the drawings, and redundant descriptions of these components are omitted.

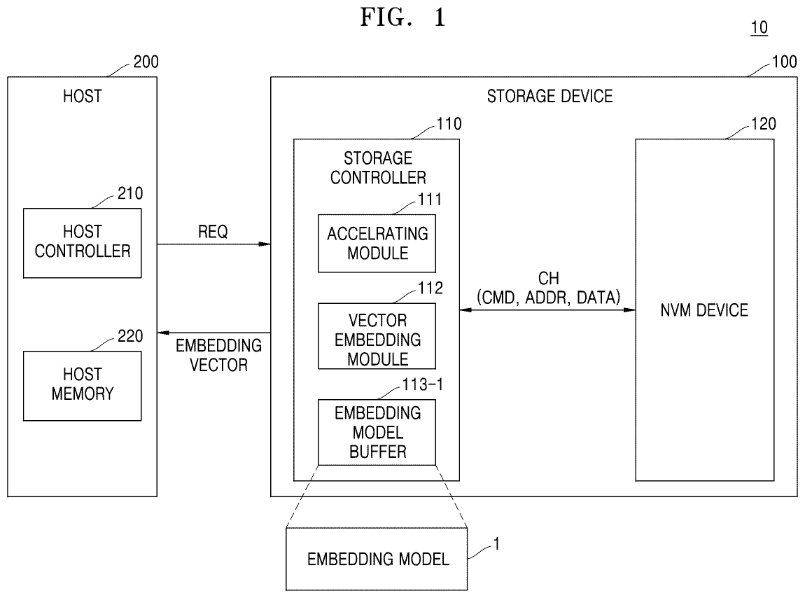

FIG. 1 illustrates a storage system 10 according to an embodiment.

Referring to FIG. 1, the storage system 10 may include a storage device 100 and a host 200, and thus, the storage system 10 may be referred to as a host-storage system.

The storage device 100 may include storage media for storing data upon request from the host 200. As an example, the storage device 100 may include at least one of a solid state drive (SSD), embedded memory, and removable external memory. In case the storage device 100 is the SSD, the storage device 100 may be a device that follows the Non-Volatile Memory express (NVMe) standard. In case the storage device 100 is an embedded memory or an external memory, the storage device 100 may be a device that follows the Universal Flash Storage (UFS) or Embedded MultiMedia Card (eMMC) standard. The host 200 and the storage device 100 may each generate packets according to an adopted standard protocol and transmit the packets the host 200 and the storage device 100.

The host 200 may include a host controller 210 and a host memory 220. The host controller 210 may manage an operation of storing data from a buffer region of the host memory 220 to a nonvolatile memory device 120, or, vice versa, storing the data from the nonvolatile memory device 120 to the buffer region of the host memory 220. The host memory 220 may function as a buffer memory for temporarily storing write data to be transmitted to the storage device 100 or read data transmitted from the storage device 100.

As an example, the host controller 210 may be one of a number of modules provided in an application processor, and the application processor may be implemented as a System on Chip (SoC). Additionally, the host memory 220 may be the embedded memory provided within the application processor, or a nonvolatile memory or memory module placed outside the application processor.

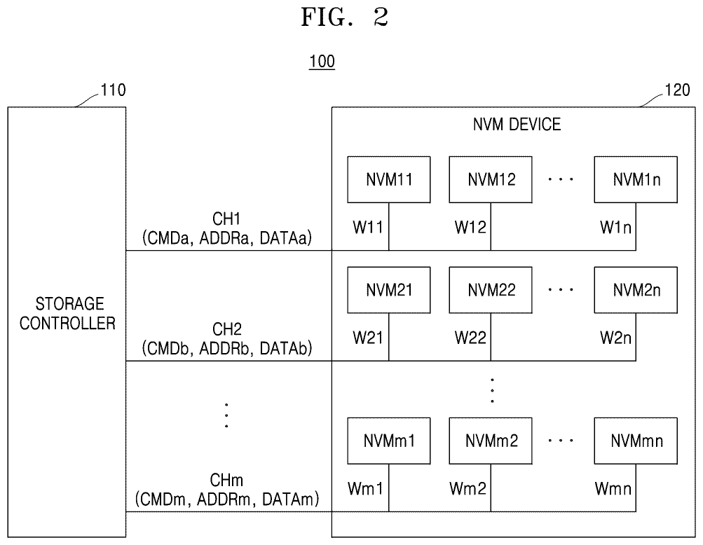

The storage device 100 may include a storage controller 110 and the nonvolatile memory device 120. According to an embodiment, the storage controller 110 may be referred to as a controller, a memory controller, or a nonvolatile memory controller. According to an embodiment, the nonvolatile memory device 120 may include a plurality of nonvolatile memories, such as a plurality of memory chips, a plurality of memory dies, or a plurality of memory planes. This will be explained in more detail with reference to FIG. 2.

The storage controller 110 may receive a request REQ from the host 200, control a memory operation for the nonvolatile memory device 120 in response to (or based on) the request REQ, and transmit a response according to the memory operation to the host 200. For example, the memory operation may include a read operation, a program operation, or an erase operation.

The storage controller 110 may be connected to the nonvolatile memory device 120 via a channel CH. The storage controller 110 may transmit and receive signals with the nonvolatile memory device 120 through the channel CH. For example, the storage controller 110 may transmit a command CMD, an address ADDR, and data to the nonvolatile memory device 120 or receive data from the nonvolatile memory device 120 through the channel CH.

The storage controller 110 may respond to the request REQ from the host 200 by transmitting an embedding vector for data corresponding to the request REQ to the host 200.

The storage controller 110 may include an accelerating module 111 that performs an embedding operation, a vector embedding module 112, and an embedding model buffer 113-1. The accelerating module 111 may perform the embedding operation. The vector embedding module 112 may control the accelerating module 111 so that the accelerating module 111 performs the embedding operation on input data based on an embedding model 1. The embedding model 1 may be loaded into the embedding model buffer 113-1.

In some embodiments, the accelerating module 111 or the vector embedding module 112 refers to a hardware component such as a processor or a circuit (included in the storage controller 110), a software component executed by a hardware component such as the storage controller 110, or combinations of the hardware component and the software component. The accelerating module 111 or the vector embedding module 112 may be implemented by a program that is stored in a storage medium which may be addressed, and is executed by a processor. For example, the accelerating module 111 or the vector embedding module 112 may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters. Through the present disclosure, the accelerating module 111 may be interchangeable with an accelerator, an accelerating component, an accelerating processor, an accelerating code, or accelerating computer codes. Also, the vector embedding module 112 may be interchangeable with a vector embedding code, vector embedding computer codes, a vector embedding processor, or a vector embedding component.

Here, the embedding model 1 may refer to a model that converts high-dimensional data (e.g., text data or image data) into a low-dimensional vector space and generates the embedding vector so that a computer can understand and process the embedding vector. For example, the embedding model 1 may correspond to the Word to Vector (Word2Vec), the Global Vectors for Word Representation (GloVe), the Bidirectional Encoder Representations from Transformers (BERT) Embedding models for natural language processing, and Deep Feature Embedding models for image processing. In some embodiments, the embedding model 1 may be stored in a memory or a storage device. In some embodiments, the embedding model 1 may be implemented by a dedicated processor. In some embodiments, the embedding model 1 may be implemented by one or more hardware components.

That is, since the storage controller 110 includes the accelerating module 111, the storage controller 110 (or the vector embedding module 112) may generate the embedding vector using the accelerating module 111 based on the embedding model 1 without using an external input/output (IO) path of data, and provide the generated embedding vector to the host 200.

As described above, according to an embodiment, an embedding vector generation operation may be performed ‘on-device’ in the storage device 100. This is described in detail with reference to FIGS. 2 to 9.

According to an embodiment, since the embedding vector is generated (or provided) while performing a read request (or a get request) from the host 200, the IO paths for generating (or providing) the embedding vector may be reduced. Accordingly, redundant accesses to the IO paths, which are mutually independent, may be minimized, thereby enhancing the efficiency of system resource utilization.

FIG. 2 illustrates the storage device 100 according to an embodiment.

Referring to FIG. 2, the storage device 100 may support a plurality of channels CH1 to CHm, and the nonvolatile memory device 120 and the storage controller 110 may be connected each other through the plurality of channels CH1 to CHm, where “m” is a natural number (e.g., equal to or higher than 2). The nonvolatile memory device 120 may include plurality of nonvolatile memories NVM11 to NVMmn, where “m” and “n” are natural numbers (e.g., equal to or higher than 2). Each of the plurality of nonvolatile memories NVM11 to NVMmn may be connected to one of the plurality of channels CH1 to CHm through a corresponding way.

For example, the nonvolatile memories NVM11 to NVM1n may be connected to the first channel CH1 through ways W11 to W1n, and the nonvolatile memories NVM21 to NVM2n may be connected to the second channel CH2 through ways W21 to W2n. In an embodiment, each of the nonvolatile memories NVM11 to NVMmn may be implemented in any memory unit that may operate according to individual commands from the storage controller 110. For example, each of the nonvolatile memories NVM11 to NVMmn may be implemented as a chip or a die, but the present disclosure is not limited thereto.

The storage controller 110 may transmit and receive signals to and from the nonvolatile memory device 120 through the plurality of channels CH1 to CHm. For example, the storage controller 110 may transmit commands CMDa to CMDm, addresses ADDRa to ADDRm, and data DATAa to DATAm to the nonvolatile memory device 120 or receive the data DATAa to DATAm from the nonvolatile memory device 120 through the plurality of channels CH1 to CHm.

The storage controller 110 may select one of the nonvolatile memories NVM11 to NVMmn connected to each channel through each channel and transmit and receive signals with the selected nonvolatile memory. For example, the storage controller 110 may select the nonvolatile memory NVM11 among the nonvolatile memories NVM11 to NVM1n connected to the first channel CH1. The storage controller 110 may transmit the command CMDa, address ADDRa, and data DATAa to a selected nonvolatile memory NVM11 or may receive the data DATAa from the selected nonvolatile memory NVM11 through the first channel CH1.

The storage controller 110 may transmit and receive signals to and from in parallel with the nonvolatile memory device 120 through different channels. For example, the storage controller 110 may transmit a command CMDb to the nonvolatile memory device 120 through the second channel CH2 while transmitting the command CMDa to the nonvolatile memory device 120 through the first channel CH1. For example, the storage controller 110 may receive the data DATAb from the nonvolatile memory device 120 through the second channel CH2 while receiving the data DATAa from the nonvolatile memory device 120 through the first channel CH1.

The storage controller 110 may control overall operation of the nonvolatile memory device 120. The storage controller 110 may control each of the nonvolatile memories NVM11 to NVMmn connected to the plurality of channels CH1 to CHm by transmitting signals to the plurality of channels CH1 to CHm. For example, the storage controller 110 may control a selected one of the nonvolatile memories NVM11 to NVM1n by transmitting the command CMDa and the address ADDRa to the first channel CH1.

Each of the nonvolatile memories NVM11 to NVMmn may be operated under control by the storage controller 110. For example, the nonvolatile memory NVM11 may program the data DATAa according to the command CMDa and the address ADDRa provided to the first channel CH1. For example, the data DATAb may be read from the nonvolatile memory NVM21 according to the command CMDb and the address ADDRb provided through the second channel CH2, and the read data DATAb may be transmitted to the storage controller 110.

In FIG. 2, the nonvolatile memory device 120 communicates with the storage controller 110 through m channels and including n nonvolatile memories corresponding to each channel. However, the number of channels and the number of nonvolatile memories connected to a single channel may vary according to embodiments.

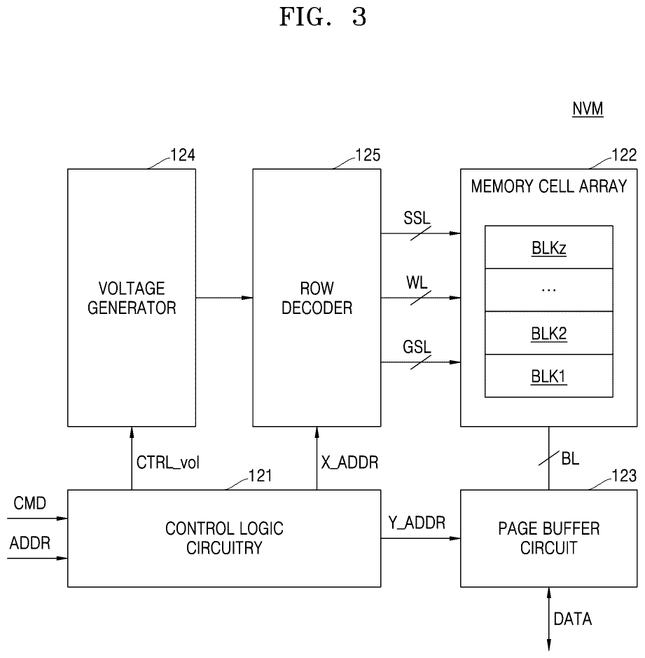

FIG. 3 illustrates a nonvolatile memory NVM according to an embodiment.

Referring to FIG. 3, the nonvolatile memory NVM may include a control logic circuitry 121, a memory cell array 122, a page buffer circuit 123, a voltage generator 124, and a row decoder 125. The nonvolatile memory NVM may correspond to the nonvolatile memory device 120 of FIG. 1 or one of the plurality of nonvolatile memories NVM11 to NVMmn of FIG. 2.

The memory cell array 122 may include plurality of memory blocks BLK1 to BLKz, each of the plurality of memory blocks BLK1 to BLKz may include plurality of cell strings, and the plurality of cell strings may include plurality of memory cells connected in series. The memory cell array 122 may be connected to the page buffer circuit 123 through bit lines BL and to the row decoder 125 through word lines WL, string select lines SSL, and ground select lines GSL.

In an embodiment, the memory cell array 122 may include a three-dimensional memory cell array that may include the plurality of cell strings. Each of the cell strings may include memory cells, each of which is connected to the word lines that are stacked vertically on a substrate. U.S. Pat. Nos. 7,679,133, 8,553,466, 8,654,587, 8,559,235, and U.S. Patent Application Publication No. 2011/0233648 are incorporated herein by reference in their entireties.

In an embodiment, the memory cell array 122 may include flash memory, which may include a 2D NAND memory array or a 3D vertical NAND (V-NAND) memory array. In an embodiment, the memory cell array 122 may include magnetic RAM (MRAM), spin-transfer torque MRAM (STT-MRAM), conductive bridging RAM (CBRAM), ferroelectric RAM (FeRAM), phase-change RAM (PRAM), resistive RAM (ReRAM), and various other types of memory.

The control logic circuitry 121 may control various operations within the nonvolatile memory NVM. The control logic circuitry 121 may output various control signals in response to the command CMD and/or the address ADDR. For example, the control logic circuitry 121 may output a voltage control signal CTRL_vol, a row address X_ADDR, and a column address Y_ADDR. The voltage generator 124 may generate various types of voltages for performing the program, read, and erase operations based on the voltage control signal CTRL_vol. The row decoder 125 may select at least one of the plurality of word lines WL and one of the plurality of string select lines SSL in response to the row address X_ADDR. The page buffer circuit 123 may select at least one bit line among the bit lines BL in response to the column address Y_ADDR. The page buffer circuit 123 may operate as a write driver or a sense amplifier depending on an operating mode.

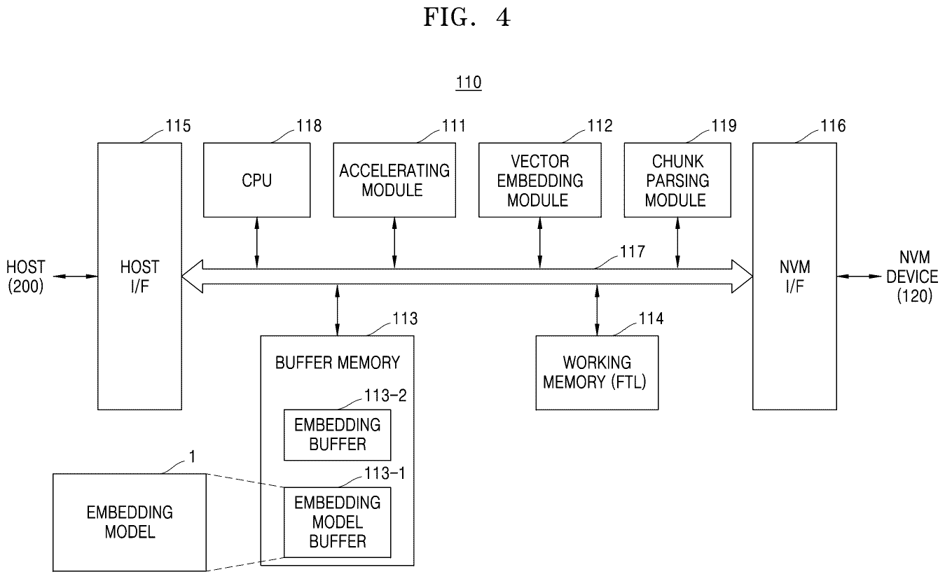

FIG. 4 illustrates the storage controller 110 according to an embodiment.

Referring to FIG. 4, the storage controller 110 may include the accelerating module 111, the vector embedding module 112, a buffer memory 113, a working memory 114, a host interface 115, a nonvolatile memory interface 116, a central processing unit (CPU) 118, and a chunk parsing module 119, which may communicate with each other through a bus 117. A Flash Translation Layer (FTL) may be loaded into the working memory 114, and a data program and read operation on the nonvolatile memory device 120 may be controlled by the CPU 118 executing the FTL.

In some embodiments, the chunk parsing module 119 refers to a hardware component such as a processor or a circuit, a software component executed by a hardware component, or combinations of the hardware component and the software component. The chunk parsing module 119 may be implemented by a program that is stored in a storage medium which may be addressed, and is executed by a processor. For example, the chunk parsing module 119 may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters. Through the present disclosure, the chunk parsing module 119 may be interchangeable with a chunk parser, an chunk parsing component, an chunk parsing processor, an chunk parsing code, or chunk parsing computer codes.

The host interface 115 may transmit and receive packets with the host 200. A packet transmitted from the host 200 to the host interface 115 may include a command or write data to be stored in the nonvolatile memory device 120, and a packet transmitted from the host interface 115 to the host 200 may include a response to a command or read data received from the nonvolatile memory device 120.

In an embodiment, the host interface 115 may sequentially receive plurality of requests from the host 200 and sequentially transmit plurality of responses or plurality of pieces of read data to the host 200 in response to the plurality of requests. For example, the host interface 115 may sequentially receive plurality of read requests from the host 200 and sequentially transmit plurality of pieces of read data to the host 200 in response to the plurality of read requests.

In an embodiment, the host 200 and the storage device 100 may communicate with each other based on a predefined interface. The predefined interface may support at least one of various interfaces such as the Universal Serial Bus (USB), Small Computer System Interface (SCSI), PCI express, ATA, Parallel ATA (PATA), Serial ATA (SATA), Serial Attached SCSI (SAS), UFS, NVMe, Compute eXpress Link (CXL), etc., but the scope of the present disclosure is not limited thereto.

The accelerating module 111 may perform the embedding operation. That is, the accelerating module 111 may generate the embedding vector by performing the embedding operation on input data based on the embedding model 1. Here, for example, the accelerating module 111 may include a dedicated circuit for high-speed data operations, such as a Graphics Processing Unit (GPU), a Neural Processing Unit (NPU), and/or a Data Processing Unit (DPU). Additionally, the embedding operation refers to an operation of transforming input data (e.g., words, sentences, images, etc.) into a vector space. That is, the embedding operation may refer to an operation of mapping the input data to an embedding vector.

In an embodiment, the accelerating module 111 may generate the embedding vector based on the embedding model 1 loaded into the embedding model buffer 113-1 under control by the vector embedding module 112.

The vector embedding module 112 may control the accelerating module 111 so that the accelerating module 111 performs the embedding operation on input data based on the embedding model 1. That is, the vector embedding module 112 may perform the role of issuing commands to the accelerating module 111 to perform actual computations for embedding vector generation.

The buffer memory 113 may temporarily store write data to be written to the nonvolatile memory device 120 or read data to be read from the nonvolatile memory device 120. The buffer memory 113 may be configured to be provided within the storage controller 110, but may also be placed outside the storage controller 110. For example, the storage controller 110 may further include a buffer memory manager or a buffer memory interface for communicating with the buffer memory 113.

Additionally, the buffer memory 113 may include static random access memory (SRAM), and since the embedding vector may have a constant size regardless of the size of the input data for the embedding operation, the generated embedding vector may be stored in the SRAM.

Additionally, the buffer memory 113 may further include the embedding model buffer 113-1 and an embedding buffer 113-2.

The embedding model buffer 113-1 may temporarily store model data for the embedding model 1. In an embodiment, the embedding model 1 may be loaded into the embedding model buffer 113-1, and the embedding operation of the accelerating module 111 may be controlled by the vector embedding module 112 executing the embedding model 1.

The embedding buffer 113-2 may temporarily store an intermediate embedding vector required for generating a final embedding vector. The accelerating module 111 may need the intermediate embedding vector, which is an intermediate result of the embedding operation, to generate the embedding vector, and the embedding buffer 113-2 may temporarily store the intermediate embedding vector.

The chunk parsing module 119 may process data read from the nonvolatile memory device 120 to generate chunk data. Here, the chunk data may refer to input data for the embedding operation of the accelerating module 111. In addition, the data read from the nonvolatile memory device 120 may be text data in units of pages, such as 4 KB or 8 KB, as raw data, and the read raw data may not be directly used in the embedding operation.

In an embodiment, the chunk parsing module 119 may generate chunk data by segmenting the raw data read from the nonvolatile memory device 120 into semantic units. For example, the chunk parsing module 119 may semantically analyze the read raw data and divide the same into the meaningful units such as words, sentences, and paragraphs as needed. That is, the chunk data may be text data of at least one unit among the words, sentences, and paragraphs.

In some embodiments, the chunk parsing module 119 may convert page-unit data (read raw data) into meaningful unit data (chunk data).

The nonvolatile memory interface 116 may transmit write data to be written to the nonvolatile memory device 120 to the nonvolatile memory device 120 or receive read data read from the nonvolatile memory device 120. The nonvolatile memory interface 116 as such may be implemented to comply with standard protocols such as Toggle NAND Interface or Open NAND Flash Interface (ONFI).

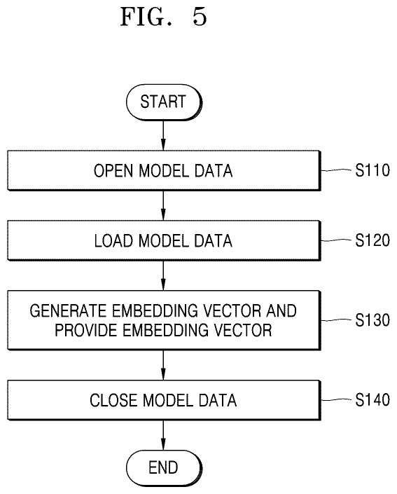

FIG. 5 illustrates an operating method of the storage device 100, according to an embodiment.

Referring to FIG. 5, the operating method of the storage device according to the present embodiment may include, for example, operations performed in time series in the storage device 100 shown in FIG. 1. The details described above with reference to FIGS. 1 to 4 may also be applied to the embodiment shown in FIG. 5.

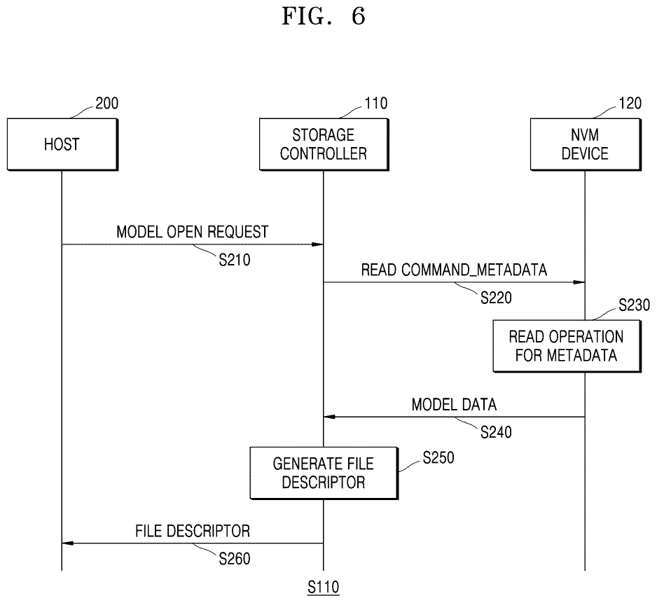

In operation S110, the storage device 100 may open the model data for the embedding model 1 stored in the nonvolatile memory device 120 in response to (or based on) a model open request from the host 200. This operation will be explained in detail with reference to FIG. 6.

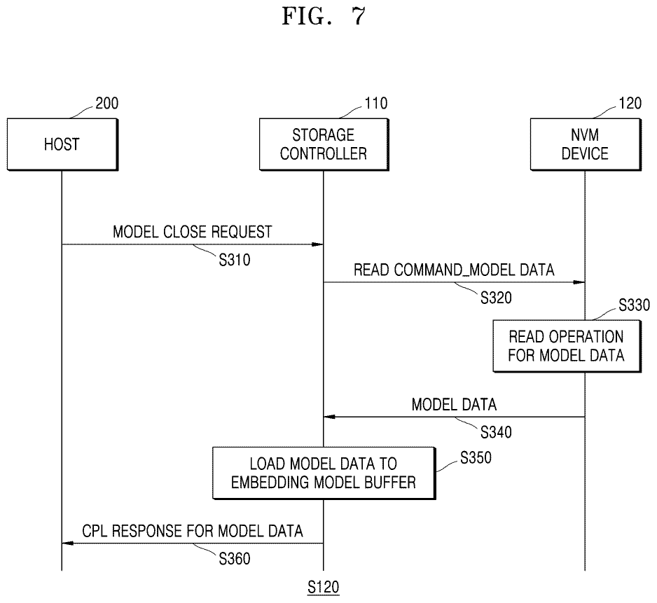

In operation S120, the storage device 100 may load the model data for the embedding model 1 stored in the nonvolatile memory device 120 into the embedding model buffer 113-1 in response to (or based on) a model read request from the host 200. This operation will be explained in detail with reference to FIG. 7.

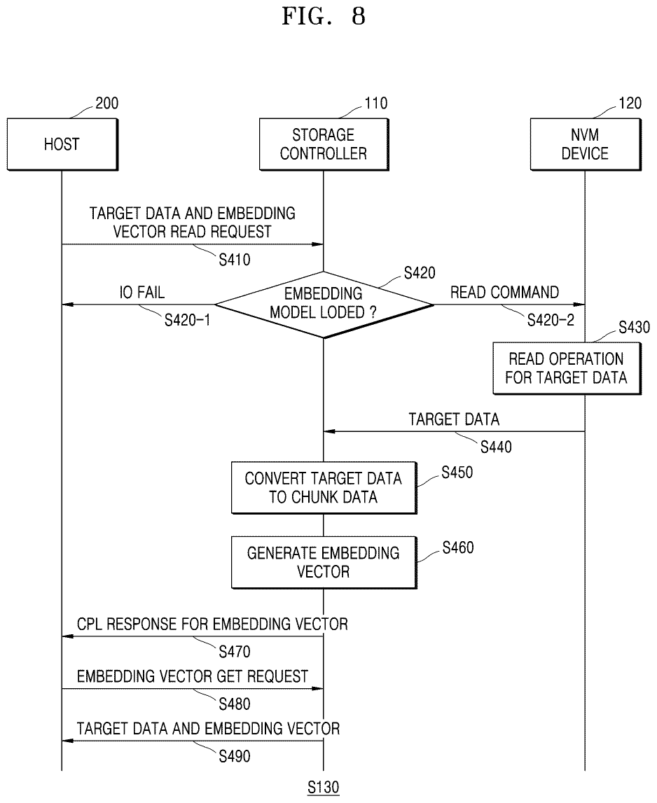

In operation S130, the storage device 100 may read target data and generate the embedding vector for the target data in response to (or based on) the read request from host 200 to read the target data and the embedding vector. Additionally, the storage device 100 may provide the host 200 with the read target data and the generated embedding vector for the target data in response to (or based on) a get request for the embedding vector from the host 200. This operation will be explained in detail with reference to FIG. 8.

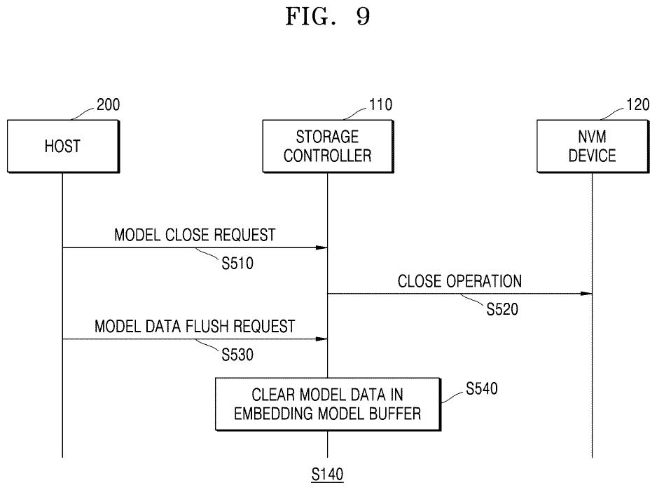

In operation S140, the storage device 100 may close the model data for the embedding model 1 in response to a request from the host 200. This operation will be explained in detail with reference to FIG. 9.

FIG. 6 illustrates an operating method of a host, a storage controller, and a nonvolatile memory device according to an embodiment.

Referring to FIG. 6, the operating method according to the present embodiment may be performed, for example, in the host 200, the storage controller 110, and the nonvolatile memory device 120 of FIG. 1. Referring to FIG. 6, opening operation (operation S110 of FIG. 5) of the model data for the embedding model 1 will be described in detail.

Here, the model data for the embedding model 1 has been pre-stored in the nonvolatile memory device 120. In addition, the model data may correspond to file data of a file system, and that metadata for the model data is also stored in advance in the nonvolatile memory device 120.

In operation S210, the host 200 may transmit the model open request to the storage controller 110. Here, the model open request may include file path information used in the file system of a directory structure, and the model open request from the host 200 may be a request for the storage device 100 to check the metadata of the model data corresponding to the file path. Here, the metadata may include information about the logical location, file size, and access rights of the model data.

That is, the host 200 may request the metadata (or a file descriptor) of the model data of the embedding model 1 from the storage device 100 based on the file path of the operating system (OS).

In operation S220, the storage controller 110 may transmit a read command for the metadata of the model data to the nonvolatile memory device 120 based on the model open request.

In operation S230, the nonvolatile memory device 120 may perform the read operation on the metadata of the model data in response to the read command on the metadata of the model data.

In operation S240, the nonvolatile memory device 120 may transmit the read metadata to the storage controller 110.

In operation S250, the storage controller 110 may generate the file descriptor based on the metadata. Here, the file descriptor is a structure for the host 200 to identify and access a file, and when requesting a specific operation (e.g., a read and/or write request for file data) from the storage device 100 of the host 200, the host 200 may refer to the file descriptor. That is, the storage controller 110 may generate the file descriptor for the model data based on the metadata.

In operation S260, the storage controller 110 may transmit the file descriptor to the host 200. Since the file descriptor is generated based on the metadata, the file descriptor may include information about a logical location (e.g., Logical Block Address (LBA)), file size, and access rights of the model data of the embedding model 1.

FIG. 7 illustrates an operating method of a host, a storage controller, and a nonvolatile memory device according to an embodiment.

Referring to FIG. 7, the operating method according to the present embodiment may be performed, for example, in the host 200, the storage controller 110, and the nonvolatile memory device 120 of FIG. 1. Referring to FIG. 7, a loading operation (operation S120 of FIG. 5) of the model data for the embedding model 1 will be described in detail.

In operation S310, the host 200 may transmit the model read request to the storage controller 110. Here, the model read request may include information about the logical address of the model data, and the model read request from the host 200 may be a request for the storage device 100 to load the model data of the embedding model 1 corresponding to a logical address from the nonvolatile memory device 120 into the embedding model buffer 113-1.

That is, the host 200 may request the storage device 100 to load the model data corresponding to the logical address included in the model read request from the nonvolatile memory device 120 into the embedding model buffer 113-1.

In operation S320, the storage controller 110 may transmit the read command for the model data to the nonvolatile memory device 120 based on the model read request. That is, the storage controller 110 may transmit the read command for the model data to the nonvolatile memory device 120 based on the logical address included in the model read request.

In operation S330, the nonvolatile memory device 120 may perform the read operation on the model data in response to the read command for the model data.

In operation S340, the nonvolatile memory device 120 may transmit the model data of the read embedding model 1 to the storage controller 110.

In operation S350, the storage controller 110 may load the model data of the embedding model 1 into the embedding model buffer 113-1. That is, the storage controller 110 may store the received model data in the embedding model buffer 113-1.

In operation S360, when the model data of the embedding model 1 has finished loading into the embedding model buffer 113-1, the storage controller 110 may transmit a loading completion response for the model data to the host 200.

Here, unlike a typical read request, the storage device 100 may only load the model data corresponding to the logical address from the nonvolatile memory device 120 into the embedding model buffer 113-1 in response to (or based on) the model read request, and may not return the model data loaded into the embedding model buffer 113-1 to the host 200.

That is, the storage device 100 may only load the model data into the embedding model buffer 113-1 in response to (or based on) the model read request and not return the model data to the host 200.

FIG. 8 illustrates an operating method of a host, a storage controller, and a nonvolatile memory device, according to an embodiment.

Referring to FIG. 8, the operating method according to the present embodiment may be performed, for example, in the host 200, the storage controller 110, and the nonvolatile memory device 120 of FIG. 1. Referring to FIG. 8, an operation (operation S130 of FIG. 5) of generating and providing an embedding vector using the embedding model 1 will be described in detail.

In operation S410, the host 200 may transmit a read request for target data and an embedding vector to the storage controller 110. Here, the read request for target data and an embedding vector may include information about a logical address of the target data, and the read request for the target data and the embedding vector from the host 200 may be a request for the storage device 100 to read the target data corresponding to the logical address and generate an embedding vector for the corresponding target data.

That is, the host 200 may request the storage device 100 to read the target data corresponding to the logical address included in the read request for the target data and the embedding vector, and to generate the embedding vector for the target data.

In operation S420, the storage controller 110 may check whether the model data of the embedding model 1 has been loaded into the embedding model buffer 113-1 based on the read request for the target data and embedding vector.

In operation S420-1, based on a check result that the model data of the embedding model 1 has not been loaded into the embedding model buffer 113-1, the storage controller 110 may transmit an IO fail response to the host 200.

In operation S420-2, based on a check result that the model data of the embedding model 1 has been loaded into the embedding model buffer 113-1, the storage controller 110 may transmit the read command for the target data to the nonvolatile memory device 120 based on the logical address included in the read request for the target data and embedding vector.

In operation S430, the nonvolatile memory device 120 may perform a read operation on the target data in response to the read command for the target data.

In operation S440, the nonvolatile memory device 120 may transmit the read target data to the storage controller 110.

In operation S450, the storage controller 110 may convert the received target data into the chunk data.

For example, the chunk parsing module 119 of the storage controller 110 may process the target data read from the nonvolatile memory device 120 to generate the chunk data. Here, the chunk data may refer to input data for the embedding operation of the accelerating module 111. In addition, the target data read from the nonvolatile memory device 120 may be text data in units of pages, such as 4 KB or 8 KB, as raw data, and the read target data may not be directly used in the embedding operation.

In an embodiment, the chunk parsing module 119 may generate the chunk data by segmenting the target data read from the nonvolatile memory device 120 into the meaningful units. For example, the chunk parsing module 119 may semantically analyze the read target data and segment the same into the meaningful units such as words, sentences, and paragraphs as needed. That is, chunk data may be text data of at least one unit among word, sentence, and paragraph.

That is, the chunk parsing module 119 may convert the target data in page units into the chunk data of the meaningful units.

In operation S460, the storage controller 110 may generate the embedding vector by performing the embedding operation on the chunk data.

For example, the vector embedding module 112 of the storage controller 110 may control the accelerating module 111 of the storage controller 110 to perform the embedding operation on the chunk data based on the embedding model 1.

That is, the accelerating module 111 may generate the embedding vector for the chunk data based on the embedding model 1 loaded into the embedding model buffer 113-1 according to the control of the vector embedding module 112.

Additionally, the embedding buffer 113-2 of the storage controller 110 may temporarily store the intermediate embedding vector required for generating the final embedding vector. The accelerating module 111 may need the intermediate embedding vector, which is an intermediate result of the embedding operation, to generate the embedding vector, and the embedding buffer 113-2 may temporarily store the intermediate embedding vector.

In operation S470, when the generation of the embedding vector is completed, the storage controller 110 may transmit a generation completion response for the embedding vector to the host 200.

In operation S480, the host 200 may transmit the get request for embedding vector to the storage controller 110.

In operation S490, the storage controller 110 may transmit target data and an embedding vector for the target data to the host 200 in response to (or based on) the get request for the embedding vector.

Here, the get request for the embedding vector from the host 200 may be a request for the storage device 100 to return the target data and the embedding vector for the target data.

FIG. 9 illustrates an operating method of a host, a storage controller, and a nonvolatile memory device, according to an embodiment.

Referring to FIG. 9, the operating method according to the present embodiment may be performed, for example, in the host 200, the storage controller 110, and the nonvolatile memory device 120 shown in of FIG. 1. Referring to FIG. 9, the operation (operation S140 of FIG. 5) of closing the model data for the embedding model 1 will be described in detail.

In operation S510, the host 200 may transmit a model close request to the storage controller 110. Here, the model close request from the host 200 may be a request for the storage device 100 to release the file descriptor for the model data.

That is, by requesting the storage device 100 to close the model data of the embedding model 1, the host 200 may terminate its reference to the model data.

In operation S520, the storage controller 110 may perform a close operation on the model data to the nonvolatile memory device 120 based on the model close request.

For example, the storage controller 110 may control the nonvolatile memory device 120 to release the corresponding file descriptor. The file descriptor may be released so that the file descriptor is no longer used by the nonvolatile memory device 120. That is, any connections referencing a file, for example, the model data, may be terminated.

Additionally, in case the model data has been mapped to a specific address range of virtual memory, the storage controller 110 may unmap the model data. This allows the virtual address space to be reclaimed and used for other operations.

Additionally, the storage controller 110 may update the metadata of the model data. For example, the storage controller 110 may record in the metadata of the model data that the file has been closed. The storage controller 110 may update a timestamp, such as a closed time, in the metadata of the model data. The storage controller 110 may reflect resource management statuses by reducing the reference count of the metadata of the model data or setting the count to 0.

Additionally, the storage controller 110 may control the nonvolatile memory device 120 to release the cache or buffer that was being used for the corresponding model data.

In operation S530, the host 200 may transmit a flush request for the model data to the storage controller 110. Here, the flush request from the host 200 may be a request for the storage device 100 to remove the model data loaded into the embedding model buffer 113-1.

In operation S540, the storage controller 110 may remove the model data loaded into the embedding model buffer 113-1 in response to the flush request.

As described above, according to an embodiment, the embedding vector generation operation described with reference to FIGS. 1 to 9 may be performed ‘on-device’ in the storage device 100.

According to the present disclosure, since the embedding vector is generated (or provided) while performing the read request (e.g., target data and the get request for an embedding vector of FIG. 8) (or the get request (e.g., embedding vector get request of FIG. 8)) from the host 200, the IO paths for generating (or providing) an embedding vector may be reduced. Accordingly, the redundant accesses to the IO paths, being independent of each other, may be minimized, thereby enhancing the efficiency of system resource utilization.

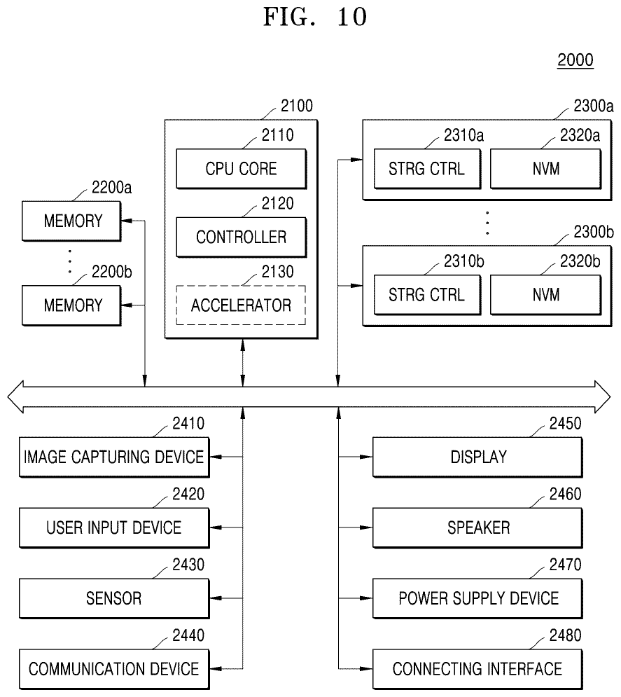

FIG. 10 illustrates a system 2000 with a storage device, according to an embodiment.

The system 2000 shown in FIG. 10 may be a mobile system, such as a mobile phone, a smartphone, a tablet personal computer, a wearable device, a healthcare device, or an Internet of Things (IoT) device. However, the system 2000 shown in FIG. 10 is not necessarily limited to a mobile system, and may be a personal computer, a laptop computer, a server, a media player, or an automotive device such as a navigation system. Referring to FIG. 10, the system 2000 may include a main processor 2100, memories 2200a and 2200b, storage devices 2300a, 2300b, and may additionally include one or more of an image capturing device 2410, a user input device 2420, a sensor 2430, a communication device 2440, a display 2450, a speaker 2460, a power supply device 2470, and a connecting interface 2480.

The main processor 2100 may control overall operations of the system 2000, more specifically, operations of other components that constitute the system 2000. The main processor 2100 as such may be implemented as a general-purpose processor, a dedicated processor, or the application processor. The main processor 2100 may include one or more CPU cores 2110 and may further include a controller 2120 for controlling the memories 2200a and 2200b and/or the storage devices 2300a and 2300b. According to an embodiment, the main processor 2100 may further include an accelerator 2130, which is a dedicated circuit for high-speed data operations such as artificial intelligence (AI) data operation. The accelerator 2130 as such may include a GPU, a NPU, and/or a DPU, and may be implemented as a separate chip that is physically independent from other components of the main processor 2100.

The memories 2200a and 2200b may be used as a main memory device of the system 2000 and may include one or more volatile memories, such as SRAM and/or DRAM, but may also include one or more nonvolatile memories, such as flash memory, PRAM, and/or RRAM. The memories 2200a and 2200b may also be implemented within the same package as the main processor 2100.

The storage devices 2300a and 2300b may function as a nonvolatile storage device that stores data regardless of whether power is supplied to them, and may have a relatively large storage capacity compared to the memories 2200a and 2200b. The storage devices 2300a and 2300b may include storage controllers 2310a and 2310b, and nonvolatile memories 2320a and 2320b that store data under the control by storage controllers 2310a and 2310b. The nonvolatile memories 2320a and 2320b may include flash memory of the 2D NAND structure or the 3D V-NAND structure, but may also include other types of nonvolatile memory, such as PRAM and/or RRAM.

The storage devices 2300a and 2300b may be included in the system 2000 in a state physically separated from the main processor 2100, or may be implemented within the same package as the main processor 2100. In addition, the storage devices 2300a and 2300b, by having a form such as an SSD or a memory card, may be detachably connected to other components of the system 2000 through an interface such as the connecting interface 2480, which will be described later. The storage devices 2300a and 2300b may be devices to which standard specifications such as the UFS, eMMC or NVMe are applied, but are not necessarily limited to the above examples. The embodiments described above with reference to FIGS. 1 to 9 may be implemented in the storage devices 2300a and 2300b.

The image capturing device 2410 may record still images or moving images and may be a camera, a camcorder, and/or a webcam. The user input device 2420 may receive various types of data input from a user of the system 2000, and may be a touch pad, a keypad, a keyboard, a mouse, and/or a microphone. The sensor 2430 may detect various types of physical quantities that may be obtained from outside the system 2000 and convert the detected physical quantities into electrical signals. The sensor 2430 as such may be a temperature sensor, pressure sensor, light sensor, position sensor, acceleration sensor, biosensor, and/or gyroscope sensor.

The communication device 2440 may transmit and receive signals between other devices outside the system 2000 according to various communication protocols. The communication device 2440 as such may be implemented in a configuration that includes an antenna, a transceiver, and/or a modem. The display 2450 and the speaker 2460 may function as output devices that output visual information and auditory information, respectively, to a user of the system 2000. The power supply device 2470 may appropriately convert power supplied from a battery built into the system 2000 and/or an external power source, and supply the same to each component of the system 2000. The connecting interface 2480 may provide a connection between the system 2000 and an external device that is connected to the system 2000 and may exchange data with the system 2000.

While the present disclosure has been particularly shown and described with reference to embodiments thereof, it will be understood that various changes in form and details may be made therein without departing from the spirit and scope of the following claims.

The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” (for example, the storage controller 110) refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items. Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

What is claimed is:

1. A storage device comprising:
a storage controller including an embedding model buffer and an accelerator; and
a nonvolatile memory operatively connected to the storage controller,
wherein the nonvolatile memory is configured to store target data and model data of an embedding model, and,
wherein the storage controller is configured to:
based on a first request from a host, transmit a read command for the target data to the nonvolatile memory,
receive the target data from the nonvolatile memory, and generate an embedding vector using the accelerator based on the received target data and the model data loaded into the embedding model buffer; and
based on a second request from the host, transmit, to the host, the target data and the generated embedding vector.

2. The storage device of claim 1, wherein the storage controller is further configured to:
based on the first request, check whether the model data is loaded into the embedding model buffer;
transmit an input/output (IO) fail response to the host, based on a first check result that the model data is not loaded into the embedding model buffer; and
transmit the read command for the target data to the nonvolatile memory, based on a second check result that the model data is loaded into the embedding model buffer.

3. The storage device of claim 1, wherein the storage controller is further configured to:
convert the received target data into chunk data; and
generate the embedding vector by performing an embedding operation on the chunk data using the accelerator.

4. The storage device of claim 3, wherein the target data comprises text data in page units, and
wherein the chunk data comprises text data in at least one of a word, a sentence, or a paragraph.

5. The storage device of claim 1, wherein the storage controller is further configured to:
receive a model open request from the host;
transmit a read command for metadata of the model data to the nonvolatile memory based on the model open request;
receive the metadata from the nonvolatile memory;
generate a file descriptor based on the metadata; and
transmit the generated file descriptor to the host.

6. The storage device of claim 1, wherein the storage controller is further configured to:
receive a model read request from the host;
transmit a read command for the model data to the nonvolatile memory based on the model read request;
receive the model data from the nonvolatile memory; and
load the model data into the embedding model buffer.

7. The storage device of claim 1, wherein the storage controller is further configured to:
receive a model close request from the host, and perform a close operation on the model data in the nonvolatile memory based on the model close request; and
receive a model data flush request from the host, and remove the model data loaded into the embedding model buffer based on the model data flush request.

8. A storage controller configured to control a nonvolatile memory where target data and model data of an embedding model are stored, the storage controller comprising:
an embedding model buffer; and
an accelerator,
wherein the storage controller is configured to:
based on a first request from a host, transmit a read command for the target data to the nonvolatile memory,
receive the target data from the nonvolatile memory, and
generate an embedding vector using the accelerator based on the received target data and the model data loaded into the embedding model buffer; and
based on a second request of the host, transmit the target data and the generated embedding vector to the host.

9. The storage controller of claim 8, wherein the storage controller is further configured to:
check, based on the first request, whether the model data is loaded into the embedding model buffer;
transmit an input/output (IO) fail response to the host, based on a first check result that the model data is not loaded into the embedding model buffer; and
transmit the read command for the target data to the nonvolatile memory, based on a second check result that the model data is loaded into the embedding model buffer.

10. The storage controller of claim 8, wherein the storage controller is further configured to:
convert the received target data into chunk data; and
generate the embedding vector by performing an embedding operation on the chunk data, using the accelerator.

11. The storage controller of claim 10, wherein the target data comprises text data in page units, and
wherein the chunk data comprises text data in at least one of a word, a sentence, or a paragraph.

12. The storage controller of claim 8, wherein the storage controller is further configured to:
receive a model open request from the host;
transmit a read command for metadata of the model data to the nonvolatile memory based on the model open request;
receive the metadata from the nonvolatile memory;
generate a file descriptor based on the metadata; and
transmit the generated file descriptor to the host.

13. The storage controller of claim 8, wherein the storage controller is further configured to:
receive a model read request from the host;
transmit a read command for the model data to the nonvolatile memory based on the model read request;
receive the model data from the nonvolatile memory; and
load the model data into the embedding model buffer.

14. The storage controller of claim 8, wherein the storage controller is further configured to:
receive a model close request from the host, and perform a close operation on the model data in the nonvolatile memory based on the model close request; and
receive a model data flush request from the host, and remove the model data loaded into the embedding model buffer based on the model data flush request.

15. An operating method of a storage controller including an embedding model buffer and an accelerator, and controlling a nonvolatile memory, the operating method comprising:
transmitting a read command for target data to the nonvolatile memory based on a first request from a host;
receiving the target data from the nonvolatile memory, and generating an embedding vector using the accelerator based on the received target data and model data loaded into the embedding model buffer; and
based on a second request from the host, transmitting the target data and the generated embedding vector to the host.

16. The operating method of claim 15, wherein the transmitting of the read command for the target data to the nonvolatile memory, further comprises:
checking, based on the first request, whether the model data of an embedding model is loaded into the embedding model buffer;
transmitting an input/output (IO) fail response to the host, based on a first check result that the model data of the embedding model is not loaded into the embedding model buffer; and
transmitting the read command for the target data to the nonvolatile memory, based on a second check result that the model data of the embedding model is loaded into the embedding model buffer.

17. The operating method of claim 15, wherein the generating of the embedding vector comprises:
converting the received target data into chunk data; and
generating the embedding vector by performing an embedding operation on the chunk data using the accelerator.

18. The operating method of claim 17, wherein the target data comprises text data in page units, and
the chunk data comprises text data in at least one of a word, a sentence, or a paragraph.

19. The operating method of claim 15, further comprising:
receiving a model open request from the host, and transmitting a read command for metadata, stored in the nonvolatile memory, of the model data to the nonvolatile memory based on the model open request; and
receiving the metadata from the nonvolatile memory, generating a file descriptor based on the metadata, and transmitting the generated file descriptor to the host.

20. The operating method of claim 15, further comprising:
receiving a model read request from the host, and transmitting a read command for the model data stored in the nonvolatile memory to the nonvolatile memory based on the model read request; and
receiving the model data from the nonvolatile memory, and loading the model data into the embedding model buffer.
